(19) United States
(12) Patent Application Publication
(10) Pub. No.: US 2003/0127321 A1
(43) Pub. Date: Jul. 10, 2003

(54) Asbestos-free diaphragm, comprising non-fibrous mineral particles, combination comprising same, method for obtaining same and use thereof

(76) Inventors: Jean-Guy Le Helloco, Levallois-Perret (FR); Jean-Maurice Perineau, Claix (FR)

Correspondence Address: BURNS DOANE SWECKER & MATHIS L L P, POST OFFICE BOX 1404, ALEXANDRIA, VA, 22313-1404, US

(21) Appl. No.: 10/169,013

(22) PCT Filed: Dec. 28, 2000
(86) PCT No.: PCT/FR00/03732

(30) Foreign Application Priority Data
Dec. 30, 1999 (FR) 9916752

(51) Int. Cl. C25B 11/00; B23H 3/04; B23H 5/10; C25F 7/00; B23H 7/22; C25D 17/10; C25C 7/02; C25C 7/04; C25B 13/00; B05D 5/12; B05D 5/00; B05D 3/02

(52) U.S. Cl. 204/284; 204/290.05; 204/296; 427/58; 427/247; 427/388.1

(57) ABSTRACT

The invention concerns a microporous diaphragm obtainable by filtering through a porous support, an aqueous dispersion free of asbestos fibres and titanate fibres, comprising organic fibres, at least a binding agent selected among halogenated polymers, at least a pore-forming agent and mineral particles with non-fibrous structure. The invention also concerns a combination comprising said diaphragm and a fibrous mat obtainable by filtration deposit through a porous support of a dispersion comprising fibres whereof part is electrically conductive, at least a binding agent selected among halogenated polymers, at least an electrolytic agent, at least a pore-forming agent. The invention further concerns the preparation of the diaphragm and the combination, and the use thereof to obtain an alkali metal hydroxide solution by electrolysis of aqueous alkali metal halide solutions.

A subject matter of the present invention is a diaphragm obtained by deposition of a fibrous sheet devoid of asbestos fibers and of titanate fibers, and a combination comprising it. It likewise relates to the preparation of the diaphragm and of said combination and to the use of these in producing an alkali metal hydroxide solution by electrolysis of aqueous solutions of alkali metal halides.

In a general way, it is known to prepare diaphragms by depositing asbestos fibers on a support, by consolidating the fibers with a polymer which is inert with respect to the electrolyte and by optionally adding a pore-forming agent, which is removed at the end of the preparation, so as to confer the necessary porosity on the diaphragms.

These diaphragms, while they have advantages as regards performance, exhibit the disadvantage, however, of comprising asbestos fibers among their constituent components.

The disclosure has been made, in European patent EP 412 917, of asbestos-free diaphragms obtained from suspensions comprising, in addition to the fluoropolymer used as binder and the pore-forming agent, a mixture of fibers and optionally a hydroxide oxide gel of a metal. The mixture of fibers comprises, on the one hand, polytetrafluoroethylene fibers and, on the other hand, inorganic fibers which are selected from carbon fibers, graphite fibers and titanate fibers. It should be noted that the content of carbon fibers and of graphite fibers has to be limited so that the resulting diaphragm has an appropriate resistivity.

It is an object of the present invention to provide a diaphragm which is devoid both of asbestos fibers and of titanate fibers.

Thus, a first subject matter of the invention relates to a microporous diaphragm capable of being obtained by filtration through a porous support of an aqueous dispersion devoid of asbestos fibers and of titanate fibers, comprising organic fibers, at least one binder selected from halogenated polymers, at least one pore-forming agent and inorganic particles with a nonfibrous structure.

The second subject matter of the invention is a combination comprising said diaphragm and a precathode composed of a fibrous sheet capable of being obtained by deposition, by filtration through a porous support, of a dispersion comprising fibers, a portion of which is electrically conducting, at least one binder selected from halogenated polymers, at least one electrocatalytic agent and at least one pore-forming agent.

A third subject matter of the invention is a process for the preparation of a diaphragm, which consists in carrying out the following stages:

a) a dispersion is prepared comprising organic fibers, at least one binder selected from halogenated polymers, at least one pore-forming agent and inorganic particles with a nonfibrous structure,

b) the dispersion thus obtained is deposited by filtration under vacuum through a porous support,

c) the liquid is removed and, if necessary, the fibrous sheet formed is dried,

d) the fibrous sheet is sintered,

e) if necessary, the pore-forming agent is removed.

The preparation of the abovementioned combination constitutes another subject matter of the present invention. The latter consists in carrying out the following stages:

a) an aqueous dispersion is prepared comprising the fibers, a portion of which is electrically conducting, at least one binder selected from halogenated polymers, at least one electrocatalytic agent and at least one pore-forming agent,

b) a fibrous sheet is deposited by filtration under programmed vacuum of said dispersion through a porous support,

c) the liquid is removed and, if necessary, the fibrous sheet formed, constituting the precathode, is dried,

d) the precathode is optionally sintered,

e) the pore-forming agent is optionally removed,

f) an aqueous dispersion, comprising organic fibers, at least one binder selected from halogenated polymers, at least one pore-forming agent and inorganic particles with a nonfibrous structure, is deposited on the precathode by filtration under programmed vacuum,

g) the liquid is removed and the diaphragm thus formed is optionally dried,

h) the assembly is sintered,

j) if necessary, the pore-forming agent is removed.

Finally, the present invention relates to the use of the diaphragm or of the combination comprising it in the electrolysis of aqueous solutions of alkali metal halides.

It has been found, surprisingly, that the use of particles with a nonfibrous structure, in combination with organic fibers based in particular on a halogenated polymer, makes it possible to obtain a diaphragm with mechanical properties, such as resistance to elongation or tear strength, which are similar to those obtained with diaphragms comprising organic and inorganic fibers.

Furthermore, the porosity characteristics also correspond to the criteria for use in cells for the electrolysis of aqueous solutions of alkali metal halides.

In point of fact, there is nothing to lead a person skilled in the art to suppose that a diaphragm comprising only organic fibers and inorganic particles with a nonfibrous structure could attain such objectives.

This is because, previously, attempts were made to replace asbestos fibers by materials with a fibrous structure, that is to say exhibiting a length/diameter ratio of at least 10, such as, in particular, titanate fibers. It was therefore far from being obvious to a person skilled in the art that particles, with a morphology so radically different from that of fibers, could have satisfactory reinforcing properties.

However, other characteristics and advantages of the present invention will become more clearly apparent on reading the description and examples which will follow.

As was indicated previously, the diaphragm according to the invention is capable of being obtained by deposition, by filtration through a porous support, of a dispersion comprising organic fibers, at least one binder selected from halogenated polymers, at least one pore-forming agent and inorganic particles with a nonfibrous structure.

The organic fibers are preferably based on a halogenated polymer selected from homopolymers or copolymers derived, at least in part, from olefinic monomers substituted by fluorine atoms or substituted by a combination of fluorine atoms and of at least one from the chlorine, bromine or iodine atoms per monomer.

Examples of fluorinated homopolymers or copolymers can be composed of polymers or copolymers derived from tetrafluoroethylene, hexafluoropropylene, chlorotrifluoroethylene or bromotrifluoroethylene.

Such fluoropolymers can also comprise up to 75 mol % of units derived from other ethylenically unsaturated monomers comprising at least as many fluorine atoms as carbon atoms, such as, for example, vinylidene (di)fluoride or vinyl perfluoroalkyl esters, such as perfluoroalkoxyethylene.

Use may naturally be made, in the invention, of several fluorinated homopolymers or copolymers as defined above.

It goes without saying that it would not be departing from the scope of the present invention to combine, with these fluoropolymers, a small amount, for example up to 10 or 15% by weight, of polymer which does not include fluorine atoms in its molecule, such as, for example, polypropylene.

According to a preferred embodiment of the invention, the organic fibers are polytetrafluoroethylene fibers.

The organic fibers used in the context of the present invention can exhibit variable dimensions. Generally, the diameter is between 10 and 500 μm and the length is such that the length/diameter ratio varies between 5 and 500. Preferably, recourse is had to fibers with mean dimensions of between 50 and 200 μm for the diameter and 1 to 10 mm for the length.

Their preparation is disclosed in particular in U.S. Pat. No. 4,444,640.

Conventionally, the content of organic fibers in the dispersion represents 100 parts by weight. In what will follow, the contents indicated, unless otherwise mentioned, are expressed as dry weight of the compound concerned.

If necessary, the diaphragm can comprise carbon fibers or graphite fibers.

More particularly, these fibers are provided in the form of filaments, the diameter of which is generally less than 1 mm and more particularly between 10⁻³ and 0.1 mm and the length of which is greater than 0.5 mm and more especially between 1 and 20 mm.

Furthermore, said fibers exhibit, according to a specific embodiment, a monodispersed length distribution, that is to say a distribution such that the length of at least 80% and advantageously of at least 90% of the fibers corresponds to the mean length to within about ±10%.

The content of carbon fibers, of graphite fibers or of their mixture, if they are present, is such that it does not confer a conductive nature on the diaphragm (the resistivity of the diaphragm is greater than or equal to 4 Ω.cm). More specifically, the content is between 2 and 10 parts by weight per 100 parts by weight of organic fibers.

The dispersion from which the diaphragm according to the invention can be obtained furthermore comprises a binding agent selected from halogenated polymers.

That which has just been disclosed on the subject of the nature of the halogenated polymer constituting the organic fibers remains valid and will not be taken up again here.

According to a preferred embodiment of the invention, the halogenated polymer employed as binder is polytetrafluoroethylene.

The binding agent is provided more particularly in the form of a dispersion of polymer particles, the solids content of which is between 30 and 70% by weight.

The content of binding agent represents more particularly 20 to 50 parts by weight per 100 parts by weight of organic fibers.

As was indicated previously, the dispersion employed for the preparation of the diaphragm comprises a pore-forming agent.

It is understood that, when recourse is had to pore-forming agents, the final material in principle no longer includes such agents and the porosity of said material, under the effect of the decomposition or of the removal of these pore-forming agents, is controlled.

Mention may be made, by way of illustration of pore-forming agents, of inorganic salts, which can subsequently be removed chemically (leaching, decomposition) or thermally.

The pore-forming agent is selected from compounds which can be removed chemically or thermally, or a mixture of such compounds.

According to a first embodiment of the invention, the pore-forming agent is selected from compounds which can be removed chemically.

Mention may in particular be made, by way of such compounds, of alkali metal or alkaline earth metal salts, such as halides, sulfates, sulfonates, bisulfites, phosphates, carbonates or bicarbonates. Mention may also be made of amphoteric alumina.

Still in this category of pore-forming agent, a preferred alternative form consists in using silica. This pore-forming agent is subsequently removed with an alkaline treatment, during the first use of the material (or of the diaphragm) or before the latter.

All types of silica are suitable for this use and more particularly precipitated silicas or pyrogenic silicas.

The specific surface of the silica employed is more particularly between 100 and 300 m²/g.

The amount and the particle size of the pore-forming agents are closely related to the application for which the materials are intended. Simply by way of an order of magnitude, the particle size of the pore-forming agents generally varies between 1 and 50 μm and preferably between 1 and 15 μm. With regard to the amount, and still by way of illustration, it is chosen according to the desired porosity, it being possible for the latter to reach 90%, indeed even more (according to Standard ASTM D 276-72).

According to a second embodiment of the invention, the pore-forming agent is selected from compounds which can be removed thermally, such as, for example, nanoparticulate systems (latices with a size of less than 100 nm).

The content of pore-forming agent is more particularly between 20 and 100 parts by weight per 100 parts by weight per organic fibers.

As was indicated above, the diaphragm comprises inorganic particles with a nonfibrous structure.

More particularly, said particles exhibit a particle size such that their mean size is less than 150 μm. More particularly, the mean size of the particles is at least 10 μm. According to a preferred embodiment of the invention, the mean size of the particles is between 10 and 50 μm.

In addition, according to a specific embodiment of the present invention, the particles are based on hydrated silicates comprising at least magnesium and/or aluminum and/or potassium.

Mention may be made, by way of suitable silicates and without intending to be restricted thereto, of talc, kaolin, mica, attapulgite or vermiculite.

According to a particularly advantageous and preferred alternative form of the invention, the inorganic particles participating in the composition of the dispersion exhibit a platelet structure.

As such, the particles employed are more specifically mica particles.

The content of inorganic particles in the dispersion [lacuna] more particularly between 30 and 100 parts by weight per 100 parts by weight of organic fibers.

The dispersion from which the diaphragm according to the invention can be obtained can comprise additives conventional in the field, such as, for example, at least one surfactant or at least one thickening agent, or their mixtures.

Mention may be made, among suitable surfactants, which are preferably nonionic surfactants, of ethoxylated alcohols or fluorocarbon compounds comprising functionalized groups, which are alone or as a mixture; these alcohols or these fluorocarbon compounds generally exhibit C₆ to C₂₀ carbon chains. Use is preferably made of ethoxylated alcohols which are ethoxylated alkylphenols, such as, in particular, octoxynols.

In the case where a surfactant is used, the amount introduced into the dispersion generally represents from 1 to 10 parts by weight per 100 parts by weight of organic fibers.

As regards the thickening agents, this is understood, according to the present invention, to mean a compound which increases the viscosity of the dispersion and which exhibits water-retaining properties.

Use is generally made of natural or synthetic polysaccharides. Mention may in particular be made of biopolymers obtained by fermentation of a carbohydrate under the action of microorganisms. Xanthan gum is advantageously used. Xanthan gum is synthesized using bacteria belonging to the genus Xanthomonas and more particularly to the species described in Bergey's Manual of Determinative Bacteriology (8th edition, 1974, Williams and Wilkins Co., Baltimore).

The species Xanthomonas campestris is very particularly well suited to the synthesis of xanthan gum.

Mention may be made, among the other microorganisms capable of producing polysaccharides with similar properties, of the bacteria belonging to the genus Arthrobacter, to the genus Erwinia, to the genus Azobacter or to the genus Agrobacter or of the fungi belonging to the genus Sclerotium.

In the case where the dispersion comprises thickening agents, their content generally represents between 1 and 10 parts by weight per 100 parts by weight of organic fibers.

It should be noted that the overall content of dry matter in the dispersion from which the diaphragm can be obtained is usually between 1 and 10% by weight.

The dispersion which has just been described is deposited by filtration through a porous support.

It should be noted that said support can be either another fibrous sheet (also known as precathode), which will be described in detail later, or a metal surface exhibiting openings with a size of between 20 μm and 5 mm (also known as basic cathode), or the combination of both these types of support.

In the case of a metal surface employed as porous support, the latter can more particularly be composed of cloths or screens, the mesh size, the perforations or the porosity of which can be within the range indicated previously. It can likewise exhibit one or more flat or cylindrical surfaces, commonly known as “glove fingers”, exhibiting an open surface.

This conductive metal surface can, inter alia, be composed of iron, nickel, alloys, such as, for example, stainless steel, or any material treated so as to render it even less sensitive to the corrosiveness of the medium, such as, for example, iron on which a nickel deposit would have been produced.

As was mentioned previously, the present invention relates to a combination comprising the diaphragm and another fibrous sheet (precathode) which can be obtained by deposition, by filtration through a porous support, of a dispersion comprising fibers, a portion of which is electrically conducting, at least one binder selected from halogenated polymers, at least one electrocatalytic agent and at least one pore-forming agent.

More particularly, the porous support on which this other fibrous sheet is deposited is composed of a metal surface exhibiting openings with a size of between 20 μm and 5 mm (basic cathode).

The characteristics relating to the basic cathode described in detail previously remain valid.

According to a preferred embodiment of the invention, the combination is such that the sequence, from one face to the other, is the diaphragm according to the invention, the precathode as defined above and the basic cathode.

The fibrous sheet constituting the precathode will now be described.

First of all, it should be noted that the precathode preferably exhibits a resistivity equal to or less than 0.4 Ω.cm.

As was indicated above, said sheet comprises electrically-conducting fibers. The latter can be selected from intrinsically conductive fibers or else can be treated so as to render them conductive.

More particularly, these fibers are provided in the form of filaments with a diameter generally of less than 1 mm and more particularly of between 10⁻³ and 0.1 mm and with a length of greater than 0.5 mm and more especially of between 1 and 20 mm.

According to a first, preferred, embodiment of the invention, the fibers participating in the composition of the sheet are intrinsically conductive fibers, such as, in particular, carbon fibers or graphite fibers.

Furthermore, the conductive fibers preferably exhibit a monodispersed length distribution, that is to say a distribution such that the length of at least 80% and advantageously of at least 90% of the fibers corresponds to the mean length to within about ±10%.

According to a second embodiment of the invention, use may be made of fibers resulting from material which is not electrically conducting but which are rendered conductive by a treatment. Mention may be made, by way of example, of zirconia fibers rendered conductive by chemical or electrochemical deposition of a metal, such as nickel.

The content of conductive fibers is determined so that the overall resistivity of the precathode fibrous sheet is less than or equal to 0.4 Ω.cm.

The dispersion comprises more particularly 20 per 100 parts by weight of conductive fibers. According to a preferred alternative form, the content of conductive fibers is between 50 and 90 parts by weight.

The dispersion can likewise comprise, in combination with the conductive fibers, nonconductive fibers.

These fibers are generally provided in the form of filaments with a size analogous to that given for the conductive fibers.

Mention may in particular be made, by way of illustration of nonconductive fibers, of organic fibers, such as polypropylene or polyethylene fibers, these fibers being optionally halogenated and in particular fluorinated, polyhalovinylidene fibers and in particular poly(vinylidene fluoride) fibers, or fluoropolymer fibers.

Such fibers, when they are present, are preferably polytetrafluoroethylene fibers. Reference may be made to the corresponding passage of the description giving the structural details of such fibers.

In a combination of conductive and nonconductive fibers, the proportion of nonconductive fibers is such that the resistivity of the precathode is at most 0.4 Ω.cm.

It should be noted that the content of nonconductive fibers, when they are used here, can represent up to 90% by weight and preferably can be between 20 and 70% by weight of the mixture of conductive fibers and nonconductive fibers.

The dispersion furthermore comprises at least one binder selected from halogenated polymers. That which was said on the subject of the binder participating in the composition of the dispersion from which the diaphragm can be obtained remains valid.

The binder is preferably polytetrafluoroethylene.

The content of binder in the dispersion is more particularly between 10 and 60 parts by dry weight.

The dispersion from which this precathode sheet is obtained additionally comprises at least one electrocatalytic agent.

Use may be made, as electrocatalytic agent, of any type of metal known in the field for activating the electrolysis reaction.

However, according to a first specific alternative form of the invention, use is made of a Raney metal, such as, preferably, nickel, or alternatively of a precursor of this Raney metal, consisting in fact of an alloy based on said metal in combination with another which can be easily removed. More particularly, it is an alloy comprising aluminum which can be leached out, for example by a basic treatment. This type of electrocatalytic agent has been disclosed in particular in European patent EP 296 076, to which reference may be made on this subject.

According to a second alternative form, use may be made, as electrocatalytic agent, of particles comprising a ruthenium, platinum, iridium or palladium oxide or a mixture of these oxides.

The term “mixture” is understood to mean particles comprising in themselves a mixture of oxides but also particles, based on one metal oxide, mixed with other particles comprising a different oxide. Very clearly, the intermediate combinations between these two possibilities are entirely conceivable.

Said agent can be provided in addition in the form of particles composed of an electrically-conducting support comprising a coating in the form of ruthenium, platinum, iridium or palladium oxide; these oxides being alone or as a mixture in the sense which has just been explained.

It would not be departing from the scope of the present invention to combine these two alternative forms, that is to say oxide-based particles or particles coated with an oxide.

Preferably, the electrocatalytic agent according to the invention is provided in the form of a coating of a support, such as, in particular, iron, cobalt, nickel, Raney iron, Raney cobalt, Raney nickel, elements from Columns IVA and VA of the Periodic Table, carbon or graphite. Here and throughout the description which will follow, the Periodic Table of the Elements to which reference is made is that published in the supplement to the Bulletin de la Société Chimique de France (No. 1, 1966).

This type of electrocatalytic agent is disclosed in particular in the international patent application WO 95/21950.

It should be noted, here again, that the combination of the two types of electrocatalytic agent described above is possible.

The content of electrocatalytic agent in the dispersion is more specifically between 20 and 200 parts by weight. It is preferably between 60 and 120 parts by weight.

The dispersion likewise comprises a pore-forming agent. That which was indicated above regarding the nature of this pore-forming agent remains valid, both for the general definition of this compound and for the preferred alternative forms, and will not be taken up again here.

In the case where the pore-forming agent can be removed by a chemical treatment, as is the case with silica in particular, this content is generally between 30 and 200 parts. More particularly, the amount of pore-forming agent is between 30 and 100 parts by weight.

In the case where the pore-forming agent can be removed thermally, such as for the nanoparticulate systems, the amount of this type of compound is more particularly between 10 and 200 parts by weight.

A combination of these two possibilities can be envisaged. In the latter case, the amount of pore-forming agents corresponding to a mixture of agents which can be removed chemically and thermally is more particularly between 30 and 200 parts by weight.

According to a specific alternative form of the present invention, said sheet comprises a cationic polymer.

Mention may be made, among suitable cationic polymers, of two categories of polymers, organic polymers and inorganic polymers, it being possible for these to be used alone or as a mixture.

By way of example of polymers of the first category, synthetic polymers selected from epichlorhydrin, polyimines, polyacrylamides or polyacrylamines are polymers capable of participating in the composition of the suspension employed in the invention. Polymers of natural origin, such as, in particular, cationic starches or cationic guars, are compounds suitable for the invention.

Mention may be made, among inorganic polymers, without the intention of being limited, of clays, bentonites, aluminum sulfate or polyaluminum chloride.

According to a preferred embodiment, the polymer is selected from polyacrylamines, sold in particular under the name Floerger® by Floerger, or cationic starches, such as cationic starches soluble under hot conditions (Hi-Cat® cationic starches, sold by Roquette) and cationic starches soluble under cold conditions, of the type of the cationic guars sold under the Meypro® trademark by Meyhall; it being possible for these polymers to be present alone or as a mixture.

The content of cationic polymer, if it is present, is such that the measurement of the turbidity of the supernatant liquid after separation by settling of the dispersion is greater than or equal to 50, preferably greater than or equal to 75 (the turbidity is measured by transmission at 630 nm on a turbidimeter of Methrom 662 Photometer® type; that of pure water gives a value of 100). Furthermore, the content of cationic polymer is such that excessive difficulty is not encountered in the filtration of the suspension.

In the more specific case of cationic starch, the content varies between 10 and 80 parts by dry weight and preferably between 20 and 40 parts by dry weight.

According to a preferred alternative form, the dispersion of the precathode sheet preferably comprises conductive fibers (without nonconductive fibers), a pore-forming agent, a cationic polymer and optionally other additives.

Mention may be made, among the additives which can be used in the case of this alternative form, of fibrous material, more particularly of the type of cellulose-based fibers or of cellulose-based fibers to which a positive ionic charge has been given.

Mention may be made, as positively charged cellulose fibers, of Becofloc® fibers.

In the specific case where the suspension comprises cellulose-based fibers, which are or are not positively charged, as fibrous material, their content is at most 60 parts by dry weight and preferably between 10 and 40 parts by weight.

Very clearly, the dispersion can also, but not necessarily, comprise conventional additives, such as surfactants or thickening agents.

Those participating in the composition of the dispersion making possible access to the diaphragm according to the invention can be employed in the preparation of the first sheet.

Such a sheet forms in particular the subject matter of an international patent application WO 97/24774.

A method for the preparation of the diaphragm according to the invention will now be described.

Thus, the diaphragm can be obtained by carrying out the following stages:

a) a dispersion is prepared comprising organic fibers, at least one binder selected from halogenated polymers, at least one pore-forming agent and inorganic particles with a nonfibrous structure,

b) the dispersion thus obtained is deposited by filtration under vacuum and through a porous support,

c) the liquid is removed and, if necessary, the fibrous sheet formed is dried,

d) the fibrous sheet is sintered,

e) if necessary, the pore-forming agent is removed.

The dispersion is prepared by mixing the various components which constitute it in an aqueous solution.

The contents of the various constituent components of the dispersion are such that they conform to the conditions indicated previously.

Very clearly, for the purposes of obtaining a homogeneous dispersion, the preparation of the dispersion takes place with stirring.

The filtration stage b) is carried out under vacuum. This vacuum is preferably programmed.

The sheet is deposited on the porous support by filtration under programmed vacuum. The vacuum is produced in a way known per se and can be produced continuously or in stages, to a final partial vacuum of 1.5×10³ to 5×10⁴ Pa.

The dispersion can be filtered vertically, which represents a particularly attractive advantage for an operation on the industrial scale, or horizontally.

On conclusion of the filtration stage b), the vacuum is maintained, so as to remove the liquid. Optionally, the resulting sheet can be dried, for example by bringing the temperature to a value of less than 150° C.

The resulting fibrous sheet subsequently forms the subject of a sintering or consolidation stage (stage d).

This sintering is carried out in a known way at a temperature greater than the softening point of the halogenated polymer employed as binder.

Once consolidated, the fibrous sheet constituting the diaphragm according to the invention can, if necessary, form the subject of a stage of removal of the pore-forming agent.

It should be noted that this stage can take place during the sintering operation, in the case where the pore-forming agent employed is thermally decomposable.

In the case where the pore-forming agent employed is, at least in part, selected from agents which can be removed chemically, stage e) takes place by carrying out a chemical treatment of the diaphragm, of the sheet or of their combination with an alkaline solution.

It is particularly advantageous to use the alkali metal hydroxide solution obtained by the electrolysis of the alkali metal halide solution. Thus, stage e) can be carried out by bringing the diaphragm into contact with an alkali metal hydroxide solution exhibiting a concentration of between 40 and 200 g/l. Furthermore, the temperature is more particularly between 20 and 95° C.

It should be noted that stage e) can take place prior to the use of the diaphragm or in situ, that is to say during the first use of the diaphragm or of the combination.

As regards the preparation of the combination within the meaning of the present invention, the following stages are carried out:

a) an aqueous dispersion is prepared comprising the fibers, a portion of which is electrically conducting, at least one binder selected from halogenated polymers, at least one electrocatalytic agent and at least one pore-forming agent,

b) a fibrous sheet is deposited by filtration under programmed vacuum of said dispersion through a porous support,

c) the liquid is removed and, if necessary, the fibrous sheet formed, constituting the precathode, is dried,

d) the precathode is optionally sintered,

e) the pore-forming agent is optionally removed,

f) an aqueous dispersion, comprising organic fibers, at least one binder selected from halogenated polymers, at least one pore-forming agent and inorganic particles with a nonfibrous structure, is deposited on the precathode by filtration under programmed vacuum,

g) the liquid is removed and the diaphragm thus formed is optionally dried,

h) the assembly is sintered,

j) if necessary, the pore-forming agent is removed.

The first stage is carried out similarly to that employed in the preparation of the dispersion employed in the production of the diaphragm.

The various constituent components of this precathode sheet, as well as the proportion of each of them, has been described in detail above. It is therefore sufficient to refer thereto.

This dispersion is advantageously deposited on a metal support exhibiting openings with a size of between 20 μm and 5 mm.

The deposition by filtration of the dispersion takes place under a programmed vacuum, the conditions of which were explained for the deposition of the sheet constituting the diaphragm.

The conditions of stage c) are, furthermore, similar to those employed in the preparation of the diaphragm.

The precathode sheet can be sintered by heating at a temperature greater than or equal to the softening temperature of the binder.

The removal of the pore-forming agent can take place at this stage, according to a method identical to that described during the preparation of the diaphragm. However, preferably, this stage is only carried out at the end of the process (stage i).

100 parts by weight of carbon fibers, the diameter of which is approximately 10 mm and the mean length of which is 1.5 mm,

35 parts by weight of polytetrafluoroethylene in the form of a latex with a solids content of 60%,

20 parts by weight of cationic guar (Meypro®, sold by Meyhall),

200 parts by weight of precipitated silica in the form of particles with a mean particle size of 3 μm and with a BET surface of 250 m².g⁻¹,

1.8 parts by weight of Triton X 100® from Rohm and Haas,

180 parts by weight of Raney nickel in the form of a 10 μm powder (Ni 20, sold by Procatalyse).

The cationic guar and then the other constituent components of the dispersion are introduced into the deionized water with stirring.

The suspension obtained, after having been stirred, is filtered under vacuum through a braided and rolled iron grid of “Gantois”-type steel, the opening of which is 2 mm and the wire diameter of which is 2 mm, the deposition surface area being 1.21 dm².

Partial vacuum is established in order to reach, by stages, a value of between 300×10² and 450×10² Pa. The maximum partial vacuum is maintained for approximately 15 minutes.

The assembly is then dried.

4 liters of a dispersion are prepared with stirring, the dispersion exhibiting a solids content of approximately 6.3% and comprising:

100 parts by weight of polytetrafluoroethylene fibers,

30 parts by weight of polytetrafluoroethylene in the form of a latex with a solids content of 60%,

40 parts by weight of WG 333 mica (Kaolins d'Arvor, milled to a size of 30 μm),

50 parts by weight of precipitated silica in the form of particles with a mean particle size of 3 μm and with a BET surface of 250 m².g⁻¹,

3.6 parts by weight of Triton X 100® from Rbhm and Haas.

The required volume of dispersion so that it exhibits the amount of dry matter which it is intended to deposit (in this instance 1.3 kg/m², 1.53 kg/m² and 1.8 kg/M²) is withdrawn.

The results are collated in the table below:

| | | | % Hydrogen in | |
|---|---|---|---|---|
| Test | Voltage (V) | H | the chlorine | FE (3N) |
| 1.3 kg/m² | 3.19 | 9.8 | 0.3 | >98% |
| 1.53 kg/m² | 3.27 | 14.6 | 0.3 | >97% |
| 1.8 kg/m² | 3.32 | 21 | 0.3 | >98% |

H is the hydraulic load reduced to a flow rate of 100. It corresponds to the ratio of the difference between the levels of the anolyte and of the catholyte and of the flow rate (expressed in ml/h); the ratio being multiplied by 100.
FE is the Faraday efficiency (sodium hydroxide concentration: 3N).

The results which appear in this table indicate that the performance of the cells comprising the diaphragm according to the invention is at least as good as that achieved by the cells comprising known diaphragms.

These tests furthermore show that it is possible to adapt the diaphragm to different operating conditions of the cell as a function of the weight deposited.

In addition, mechanical bursting tests on the diaphragms and combinations have shown that the values of elongation at break, the maximum stress and the maximum force render such diaphragms and combinations compatible with use in cells for the electrolysis of aqueous solutions of alkali metal halides.

1. A microporous diaphragm capable of being obtained by filtration through a porous support of an aqueous dispersion devoid of asbestos fibers and of titanate fibers, comprising organic fibers, at least one binder selected from halogenated polymers, at least one pore-forming agent and inorganic particles with a nonfibrous structure.

2. The diaphragm as claimed in the preceding claim, characterized in that the inorganic particles exhibit a particle size such that their mean size is less than 150 μm.

3. The diaphragm as claimed in the preceding claim, characterized in that the inorganic particles the particles exhibit a particle size such that their mean size is at least 10 μm and preferably of between 10 and 50 μm.

4. The diaphragm as claimed in any one of the preceding claims, characterized in that the particles are particles of hydrated silicates comprising at least magnesium and/or aluminum and/or potassium.

5. The diaphragm as claimed in claim 4, characterized in that the particles are particles of talc or of mica.

6. The diaphragm as claimed in one of the preceding claims, characterized in that the inorganic particles exhibit a platelet structure.

7. The diaphragm as claimed in any one of the preceding claims, characterized in that the content of inorganic particles is between 30 and 100 parts by weight per 100 parts by weight of organic fibers.

8. The diaphragm as claimed in any one of the preceding claims, characterized in that the organic fibers are based on a halogenated polymer selected from homopolymers or copolymers derived, at least in part, from olefinic monomers substituted by fluorine atoms or substituted by a combination of fluorine atoms and of at least one from the chlorine, bromine or iodine atoms per monomer, and preferably polytetrafluoroethylene.

9. The diaphragm as claimed in any one of the preceding claims, characterized in that the halogenated polymer employed as binder is selected from homopolymers or copolymers derived, at least in part, from olefinic monomers substituted by fluorine atoms or substituted by a combination of fluorine atoms and of at least one from the chlorine, bromine or iodine atoms per monomer, and preferably polytetrafluoroethylene.

10. The diaphragm as claimed in any one of the preceding claims, characterized in that the content of binder represents more particularly 20 to 50 parts by weight per 100 parts by weight of organic fibers.

11. The diaphragm as claimed in any one of the preceding claims, characterized in that the pore-forming agent is selected from compounds which can be removed chemically or thermally, or a mixture of such compounds.

12. The diaphragm as claimed in the preceding claim, characterized in that the pore-forming agent is silica.

13. The diaphragm as claimed in claim 11, characterized in that the pore-forming agent is selected from nanoparticulate systems (latices with a size of less than 100 nm).

14. The diaphragm as claimed in any one of the preceding claims, characterized in that the content of pore-forming agent is between 20 and 100 parts by weight per 100 parts by weight of organic fibers.

15. The diaphragm as claimed in any one of the preceding claims, characterized in that the dispersion comprises at least one surfactant or at least one thickening agent, or their mixtures.

16. The diaphragm as claimed in any one of the preceding claims, characterized in that the dispersion comprises carbon fibers or graphite fibers.

17. The diaphragm as claimed in the preceding claim, characterized in that the content of carbon fibers, of graphite fibers or of their mixture is between 2 and 10 parts by weight per 100 parts by weight of organic fibers.

18. The diaphragm as claimed in any one of the preceding claims, characterized in that the porous support can be another fibrous sheet, a metal surface exhibiting openings with a size of between 20 μm and 5 mm or else the combination of both these types of support.

19. A combination, characterized in that it comprises the diaphragm as claimed in one of claims 1 to 18 and a fibrous sheet or precathode which can be obtained by deposition, by filtration through a porous support, of a dispersion comprising fibers, a portion of which is electrically conducting, at least one binder selected from halogenated polymers, at least one electrocatalytic agent and at least one pore-forming agent.

20. The combination as claimed in the preceding claim, characterized in that the porous support is composed of a metal surface exhibiting openings with a size of between 20 μm and 5 mm, or basic cathode.

21. The combination as claimed in either of claims 19 and 20, characterized in that the sequence, from one face to the other, is the diaphragm, the precathode and the support composed of the basic cathode.

22. A preparation of the diaphragm as claimed in any one of claims 1 to 18, characterized in that the following stage are carried out:
a) a dispersion is prepared comprising organic fibers, at least one binder selected from halogenated polymers, at least one pore-forming agent and inorganic particles with a nonfibrous structure,
b) the dispersion thus obtained is deposited by filtration under vacuum and through a porous support,
c) the liquid is removed and, if necessary, the fibrous sheet formed is dried,
d) the fibrous sheet is sintered,
e) if necessary, the pore-forming agent is removed.

23. A preparation of the combination as claimed in any one of claim 19 to 21, characterized in that the following stages are carried out:
a) an aqueous suspension is prepared comprising the fibers, a portion of which is electrically conducting, at least one binder selected from halogenated polymers, at least one electrocatalytic agent and at least one pore-forming agent,
b) a fibrous sheet is deposited by filtration under programmed vacuum of said dispersion through a porous support,
c) the liquid is removed and, if necessary, the fibrous sheet formed, constituting the precathode, is dried,
d) the precathode is optionally sintered,
e) the pore-forming agent is optionally removed,
f) an aqueous dispersion, comprising organic fibers, at least one binder selected from halogenated polymers, at least one pore-forming agent and inorganic particles with a nonfibrous structure, is deposited on the precathode by filtration under programmed vacuum,
g) the liquid is removed and the diaphragm thus formed is optionally dried,
h) the assembly is sintered,
j) if necessary, the pore-forming agent is removed.

24. The process as claimed in either one of claims 22 and 23, characterized in that the removal of the pore-forming agent takes place by carrying out a chemical treatment of the diaphragm, of the sheet or of their combination with an alkaline solution.

25. The process as claimed in any one of claim 22 to 24, characterized in that the removal of the pore-forming agent takes place during the first use of the diaphragm or of the combination.

26. The process as claimed in any one of claim 22 to 25, characterized in that the removal of the pore-forming agent takes place by carrying out a heat treatment, preferably that corresponding to the sintering stage.

27. The use of the diaphragm as claimed in any one of claims 1 to 18 or of the combination as claimed in any one of claims 19 to 22 in the electrolysis of aqueous solutions of alkali metal halide.
